(19) United States
(12) Patent Application Publication
(10) Pub. No.: US 2006/0156254 A1
(43) Pub. Date: Jul. 13, 2006

(54) Image display device

(75) Inventor: Masaomi Satake, Kanagawa (JP)

Correspondence Address: HOGAN & HARTSON L.L.P., 500 S. GRAND AVENUE, SUITE 1900, LOS ANGELES, CA, 90071-2611, US

(73) Assignee: KYOCERA CORPORATION

(21) Appl. No.: 11/318,097

(22) Filed: Dec. 23, 2005

(30) Foreign Application Priority Data
Dec. 27, 2004 (JP) 2004-377866

(51) Int. Cl. G09G 5/00

(52) U.S. Cl. 715/838; 345/619

(57) ABSTRACT

An image display device has a detecting section which detects whether there is a reduced image corresponding to a landscape image (panoramic image) or not, in the plurality of reduced images which are to be index-displayed on a display section; and a display section and a thumbnail displaying section which index-display the plurality of the reduced images in a display area group (thumbnail display frames) of a display screen. When the detecting section detects the reduced image corresponding to the landscape image, thumbnail displaying section scroll-displays the reduced image corresponding to the landscape image, in the longitudinal direction in a display area (thumbnail display frame FR) where the reduced image corresponding to the landscape image is to be displayed.

### CROSS-REFERENCE TO RELATED APPLICATIONS

This application is based upon and claims the benefit of priority from the prior Japanese Patent Applications No. 2004-377866, filed on Dec. 27, 2004, the entire contents of which are incorporated herein by reference.

### BACKGROUND OF THE INVENTION

1. Field of the Invention

The present invention relates to an image display device which, for example, index-displays thumbnail images (reduced images in size).

2. Description of the Related Art

In an apparatus such as a digital camera, for example, recorded images are index-displayed (multi-screen display). A device is known which, in such a case, index-displays thumbnails (reduced images) that are obtained by reducing the images, while arranging the thumbnails on a display screen (for example, see JP-A-11-187356.).

Specifically, in usual thumbnail display, thumbnails are produced from original images so that each thumbnail can be fitted into a frame (thumbnail display frame) for displaying a thumbnail of a predetermined size, thumbnail display frames are arranged in a matrix pattern of, for example, 3 columns by 3 rows on a display screen, and the thumbnails are displayed in the thumbnail display frames.

In the case where file names of recorded images are index-displayed, for example, it is difficult to distinguish a desired image when the number of recorded image files is increased. By contrast, in thumbnail display, the contents of images can be roughly known even when a large number of image files are recorded. Therefore, thumbnail display is excellent in visibility, and enables a desired image to be distinguished in a short time period from the plurality of recorded images.

The thumbnail display is a technique in which, when the user selects a desired thumbnail, the original image of the selected thumbnail is displayed. This technique is employed in a personal computer, a digital camera, a portable telephone, and the like.

JP-A-11-187356 is referred to as a related art.

In a usual device, however, a thumbnail which is reduced to the specified size of a thumbnail display frame is produced for an image of any size. Unlike the case where an image taken by a usual camera in which the aspect ratio of a photographed image is 3:4 is displayed as a thumbnail, in the case where an image having a size which is different from the specified size, such as a landscape image (panoramic image) of an aspect ratio of about 1:5 is displayed as a thumbnail, the resulting thumbnail image has a rod-like shape which is laterally elongated as shown FIG. 12. Sometimes, it is difficult to intuitively recognize the contents of the original image at the sight of the thumbnail.

In order to solve the problem, a device is known in which a landscape image is not index-displayed but simply scroll-displayed, or a thumbnail is simply displayed in a gradually enlarging manner. In the device, however, an index of thumbnails is not displayed, and hence it is difficult to distinguish a desired image in a short time period from the plurality of recorded images.

Another device is known in which, when the plurality of thumbnails are index-displayed in the form of one row, the whole of a thumbnail positioned at the middle is displayed, and a thumbnail in an end portion is displayed while the right or left side is cut away. However, the device has the following drawback. Even when a part of a thumbnail is displayed in such a manner that, for example, the left half of a thumbnail in the right end is hidden, the whole of such a thumbnail in an end portion is hardly recognized because only a part of the whole of the thumbnail is displayed.

A further device is known in which, when a desired thumbnail is selected in a displayed index of thumbnails, only the selected thumbnail is enlarged at the same position while the display of the other indexed thumbnails is not changed. In the device, when the whole of a thumbnail is to be known, however, a cumbersome operation of selecting the thumbnail is required.

A further device is known in which, when a desired thumbnail is selected in a displayed index of thumbnails, the selected thumbnail is gradually enlarged to the full of the display. In the device, when the whole of a thumbnail is to be known, however, a cumbersome operation of selecting the thumbnail is required, and the index of the other thumbnails cannot be seen when the thumbnail is selected.

Recently, the pixel number of a recorded image of a portable apparatus such as a digital camera is increasing. Because of portability, however, a display device of a portable apparatus has limitations in number of pixels which can be displayed. In some cases, therefore, the number of pixels of a recorded image is largely different from that of a display device. When an image having a large pixel number (high-resolution image) is displayed as a thumbnail in a thumbnail frame of a specified size, the reduction ratio is excessively large as compared with a thumbnail display of an usual image, and there is a case where the thumbnail image collapses and the user cannot intuitively recognize the contents of the original image.

### SUMMARY OF THE INVENTION

An object of the invention is to provide an image display device which index-displays reduced images with good visibility even when there is a reduced image of an image having a low visibility in the reduced images (thumbnails) to be index-displayed (multi-screen display).

The invention provides an image display device, having: a displaying section which index-displays a plurality of reduced images; and an image determining section which determines whether there is a reduced image corresponding to a landscape image or not, in the plurality of the reduced images which are to be index-displayed on the displaying section, wherein when the image determining section determines the reduced image corresponding to the landscape image, the displaying section scroll-displays the reduced image corresponding to the landscape image, on a display area where the reduced image is to be displayed.

The invention also provides an image display device, having: a displaying section which index-displays a plurality of reduced images; and an image determining section which determines whether there is a reduced image corresponding to a landscape image or not, in the plurality of reduced images which are to be index-displayed on the displaying section, wherein when the image determining section determines the reduced image corresponding to the landscape image, the displaying section displays the reduced image corresponding to the landscape image while the reduced image is gradually enlarged, or while an image obtained by enlarging the reduced image corresponding to the landscape image is gradually reduced, on a display area where the reduced image is to be displayed.

The invention also provides an image display device, having: a displaying section which index-displays a plurality of reduced images; and an image determining section which determines whether there is a reduced image corresponding to a landscape image or not, in the plurality of the reduced images which are to be index-displayed on the displaying section, and wherein when the image determining section determines the reduced image corresponding to the landscape image, the displaying section displays the reduced image corresponding to the landscape image and an image obtained by enlarging the reduced image, and/or by rotating the determined image and the enlarged image on a display area where the reduced image is to be displayed at a predetermined timing.

The invention also provides an image display device, having: a displaying section which index-displays a plurality of reduced images; and a high-resolution image determining section which determines whether there is a reduced image corresponding to a high-resolution image having pixels in number equal to or larger than a predetermined number or not, in the plurality of the reduced images which are to be index-displayed on the displaying section, wherein when the high-resolution image determining section determines the reduced image corresponding to the high-resolution image, the displaying section scroll-displays the reduced image corresponding to the high-resolution image, on a display area where the reduced image is to be displayed.

According to the image display device, it is possible to provide an image display device which index-displays (multi-screen-displays) reduced images with good visibility in displaying of an index of the reduced images (thumbnails).

### BRIEF DESCRIPTION OF THE DRAWINGS

FIG. 1 is a view showing a specific example of a portable telephone in which the image display device of an embodiment is employed;

FIG. 2 is a functional block diagram of the portable telephone in which the image display device of the invention shown in FIG. 1 is employed;

FIG. 3 is a view illustrating a specific example of an operation of displaying a thumbnail according to the invention;

FIG. 4 is a flowchart illustrating a specific example of an operation of the image display device 100 shown in FIG. 2, in production of a thumbnail (reduced image);

FIG. 5 is a flowchart illustrating a specific example of an operation of the image display device 100 shown in FIG. 2, in display of a thumbnail (reduced image);

FIG. 6 is a view showing an operation of an image display device 100 of a second embodiment of the invention, in display of a thumbnail;

FIG. 7 is a flowchart illustrating a specific example of an operation of the image display device 100 shown in FIG. 6, in production of a thumbnail (reduced image);

FIG. 8 is a view showing an operation of an image display device 100 of a third embodiment of the invention, in display of a thumbnail;

FIG. 9 is a flowchart illustrating a specific example of an operation of the image display device 100 of the third embodiment of the invention, in production of a thumbnail (reduced image);

FIG. 10 is a view showing an operation of an image display device which is a fourth embodiment of the invention, in display of a thumbnail;

FIG. 11 is a flowchart illustrating an operation of the image display device shown in FIG. 10, in display of a thumbnail; and

FIG. 12 is a view illustrating usual thumbnail display.

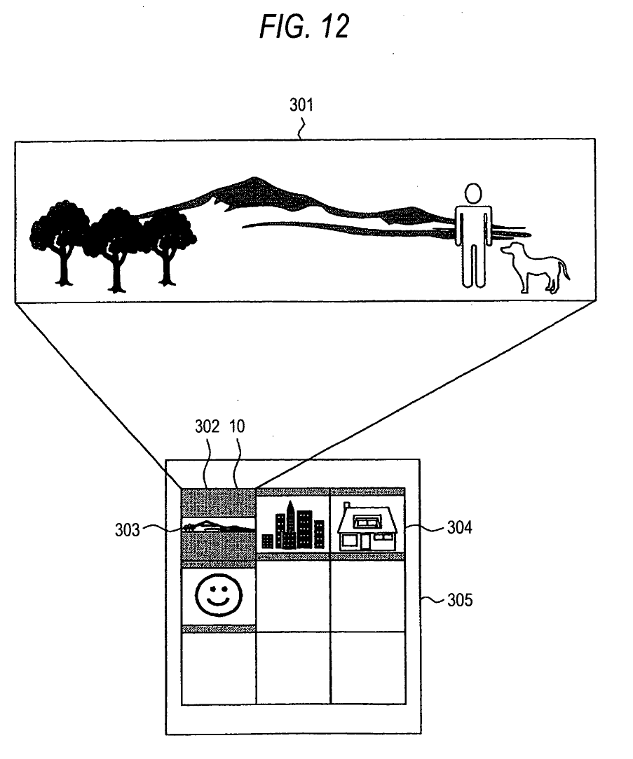

### DETAILED DESCRIPTION OF THE PREFERRED EMBODIMENTS

Embodiments of the image display device of the invention will be described with reference to the accompanying drawings.

### First Embodiment

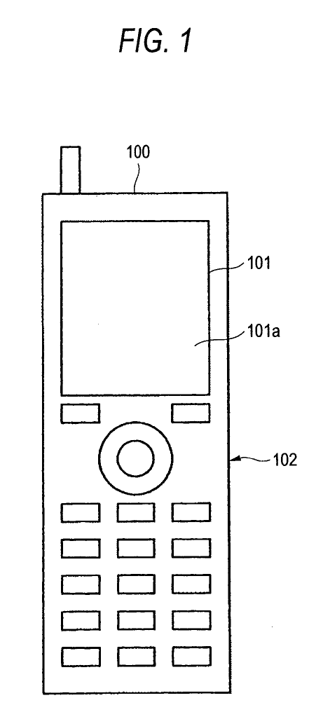

FIG. 1 shows a first embodiment of the image display device of the invention.

An image display device 100 is a display device of, for example, a personal computer, a portable telephone, a digital camera, a PDA (Personal Digital Assistant), or a wristwatch. The image display device 100 has functions of storing images, and browsing (displaying) the images. The image display device 100 may have further a communication function and a photograph function.

In the embodiment, as shown in FIG. 1, for example, a portable computer in which the image display device of the invention is employed, specifically, a portable telephone will be described.

As shown in FIG. 1, the image display device 100 has, in a front face portion, a display section 101 which performs image display according to the invention, and a key operation section 102 which is operated by the user.

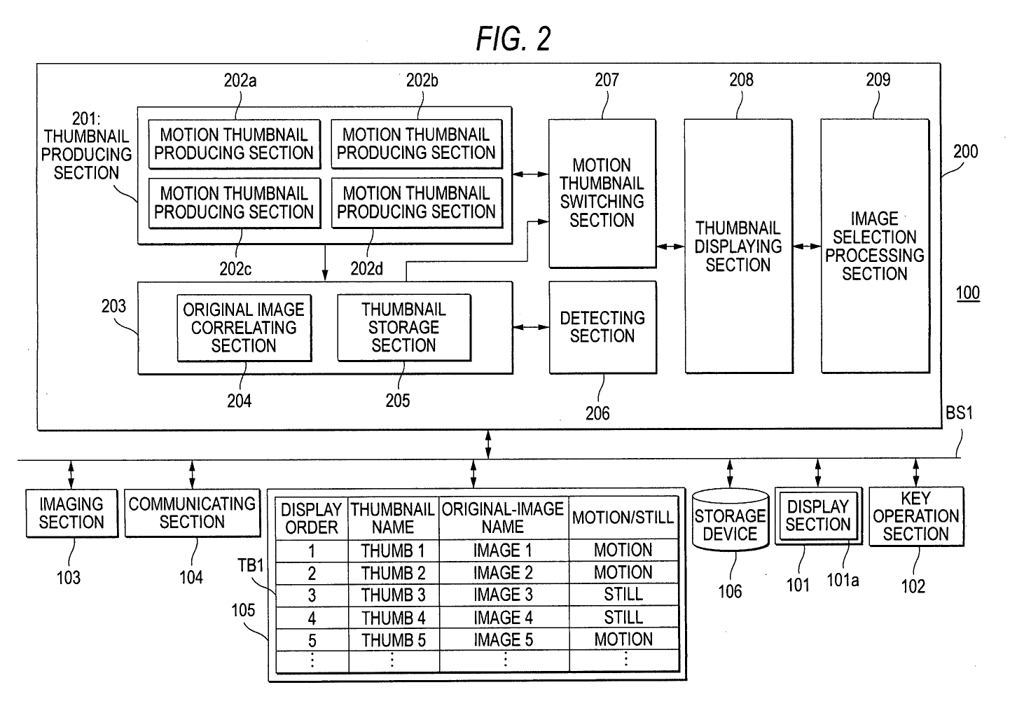

FIG. 2 is a functional block diagram of a portable telephone in which the image display device shown in FIG. 1 is employed.

As shown FIG. 2, the image display device 100 has the display section 101, the key operation section 102, an imaging section 103, a communicating section 104, a memory 105, a storage device 106, and a controlling section (CPU: Central Processing Section) 200.

The components are connected to each other by, for example, a data communication line (bus) BS1.

The display section 101 performs image display according to the invention under the control of the controlling section 200. For example, the display section 101 is a display device such as an LCD (Liquid Crystal Display) or an organic EL (ElectroLuminescence) display device.

For example, the display section 101 index-displays the plurality of reduced images in such a manner that the plurality of reduced images corresponding to original images are displayed respectively in a display area group (thumbnail display frames which are arranged in a matrix pattern) on a display screen 101a.

When a reduced image corresponding to a landscape image is detected, the display section 101 scroll-displays the reduced image corresponding to a landscape image, in a display area where the reduced image corresponding to a landscape image is to be displayed.

Specifically, as described later, the display section 101 displays a moving reduced image in which the reduced image corresponding to a landscape image is laterally scrolled.

The key operation section 102 is an input device which is operated by the user. The key operation section 102 supplies a signal according to an operation of the user, to the controlling section 200.

The imaging section 103 outputs an image which is obtained according to the result of photographing of a subject or the like, as an electric signal to the controlling section 200. For example, the imaging section 103 has an optical lens system which is not shown, a CCD (Charge Coupled Device) image pickup element or a CMOS (Complementary Metal-Oxide Semiconductor) image pickup element, an analog-digital converting circuit, etc.

The communicating section 104 performs data communication relating to an image according to the invention with, for example, another communication device under the control of the controlling section 200. For example, the communicating section 104 performs data communication by a wireless system or a wired system.

For example, the memory 105 stores programs for implementing functions according to the invention, a link table TB1 which contains data correlating original images with thumbnail images (reduced images), and the like under the control of the controlling section 200. The memory 105 is used also as a work space for the controlling section 200.

The memory 105 is configured by, for example, semiconductor memories such as a RAM (Random Access Memory) and a ROM (Read Only Memory).

The storage device 106 stores images and thumbnails (reduced images, moving reduced images, etc.) according to the invention under the control of the controlling section 200. For example, the storage device 106 has a semiconductor memory, a magnetic disk, a magnetooptical disk, or a like storage device.

The controlling section 200 implements, for example, the programs according to the invention to control the overall device.

As shown in FIG. 2, the controlling section 200 has, for example, a thumbnail producing section 201, a first motion thumbnail producing section 202a, a storage controlling section 203, an original image correlating section 204, a thumbnail storage section 205, a detecting section 206, a motion thumbnail switching section 207, a thumbnail displaying section 208, and an image selection processing section 209.

The first motion thumbnail producing section 202a corresponds to an example of the moving reduced image producing section in the invention, the storage controlling section 203, the memory 105, and the storage device 106 correspond to an example of the storage section in the invention, the detecting section 206 corresponds to an example of the image determining section in the invention, and the thumbnail displaying section 208 and the display section 101 correspond to an example of the displaying section in the invention.

The thumbnail producing section 201 produces, for example, reduced images (thumbnails) of: images photographed by the imaging section 103; images received by the communicating section 104; images stored in the storage device 106; and the like.

Specifically, the thumbnail producing section 201 produces thumbnails from original images so that each thumbnail can be fitted into a predetermined size or each of thumbnail display frames which are arranged in a matrix pattern of, for example, 3 columns by 3 rows on the display screen of the display section 101.

In a usual state, for example, the thumbnail producing section 201 produces a reduced still image (thumbnail) of a specified aspect ratio of 3:4 from an original image of a specified aspect ratio of 3:4.

The thumbnail producing section 201 has the first motion thumbnail producing section 202a.

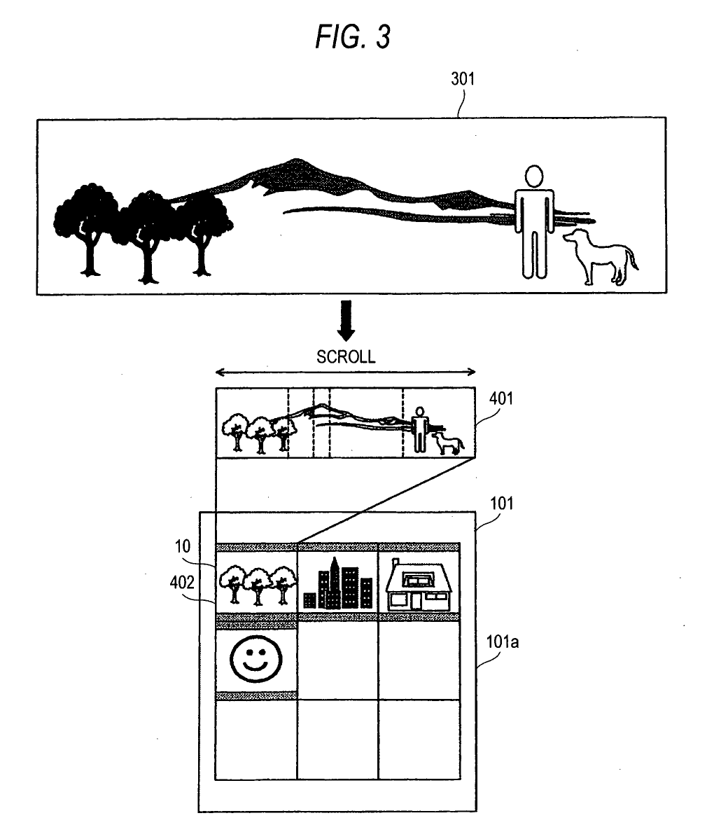

FIG. 3 is a view illustrating a motion thumbnail produced by the first motion thumbnail producing section 202a shown in FIG. 2.

As shown in FIG. 3, in each display area where a reduced image corresponding to a landscape image is to be displayed, the first motion thumbnail producing section 202a produces a moving reduced image in which the reduced image corresponding to a landscape image is scrolled, specifically a moving reduced image in which the reduced image corresponding to a landscape image is sequentially shifted in the longitudinal direction.

More specifically, in the case where an image to be subjected to a thumbnail process has a size different from a specified size, or specifically example the case where the aspect ratio of a thumbnail to be displayed in a specified thumbnail display frame 10 is 3:4 and the aspect ratio of the image 301 to be subjected to the thumbnail process is, for example, 1:5 (landscape image), the first motion thumbnail producing section 202a produces a reduced image 401 while maintaining the aspect ratio of the image 301, and further produces a moving reduced image (motion thumbnail) 402 in which, in the thumbnail display frame 10 of the specified size, the reduced image 401 corresponding to the landscape image 301 is scroll-displayed in the lateral direction (longitudinal direction).

In this case, as the motion image format of the moving reduced image 402, various known motion image formats may be used.

The thumbnail producing section 201 can set a moving reduced image (motion thumbnail) or a reduced still image (still thumbnail) as a thumbnail for each image.

The storage controlling section 203 performs a control in which, for example, the thumbnail produced by the thumbnail producing section 201, specifically, the still thumbnail or the motion thumbnail is stored in the memory 105 or the storage device 106.

As shown in FIG. 2 in detail, the storage controlling section 203 has the original image correlating section 204 and the thumbnail storage section 205.

On the basis of the thumbnail produced by the thumbnail producing section 201, the original image correlating section 204 updates the link table TB1 showing correlations between thumbnails stored in the storage device 106 and original images.

As shown in FIG. 2, for example, the link table TB1 correlatingly stores display order data, thumbnail name data, original-image name data, and attribute data.

The display order data are data indicative of the order of thumbnails which are index-displayed.

The thumbnail name data are data indicative of the names of thumbnails produced on the basis of original images.

The original-image name data are data indicative of the names of original images which are to be subjected to the thumbnail process.

The attribute data are data indicative of attributes of thumbnails such as a motion thumbnail and a still thumbnail.

The thumbnail storage section 205 stores the thumbnail produced by the thumbnail producing section 201, in the storage device 106 on the basis of, for example, the link table TB1.

The detecting section 206 determines whether there is a reduced image corresponding to a landscape image or not, in the plurality of reduced images which are to be index displayed on the display section 101, to detect the reduced image corresponding to the landscape image.

The motion thumbnail switching section 207 switches over a thumbnail to be displayed in the thumbnail display frame 10. When instructions for switching a thumbnail are input, the motion thumbnail switching section 207 switches a thumbnail displayed in the thumbnail display frame 10 to a motion thumbnail or a still thumbnail, and displays the thumbnail.

When thumbnails are switched over by the motion thumbnail switching section 207, a thumbnail may be newly produced by, for example, the thumbnail producing section 201.

On the basis of the link table TB1 stored in the memory 105, the thumbnail displaying section 208 index-displays thumbnails (moving reduced image) according to the invention in respective display areas of the display screen of the display section 101.

When the detecting section 206 detects during displaying of a thumbnail index that there is a reduced image corresponding to a landscape image, the thumbnail displaying section 208 laterally scroll-displays the reduced image corresponding to a landscape image in a display area where the reduced image corresponding to a landscape image is to be displayed.

Specifically, when the detecting section 206 detects on the basis of the link table TB1 during displaying of a thumbnail index that there is a reduced image corresponding to a landscape image, the thumbnail displaying section 208 displays the motion thumbnail which is produced by the thumbnail producing section 201 and stored in the storage device 106, and which corresponds to the landscape image, in a display area where the reduced image corresponding to a landscape image is to be displayed.

When an instruction signal for selecting a desired thumbnail from the plurality of indexed thumbnails is input from the key operation section 102 during displaying of a thumbnail index, the image selection processing section 209 reads the original image correlated to the selected thumbnail from the storage device 106 on the basis of the instruction signal and the link table TB1, and causes the original image to be displayed on the display section 101.

In the image display device 100 of the embodiment, the thumbnail producing section 201 previously produces reduced images (thumbnails), the reduced images are stored in the storage device 106, and, during displaying of thumbnails, the thumbnails read out from the storage device 106 are index-displayed.

First, an operation of producing thumbnails will be described.

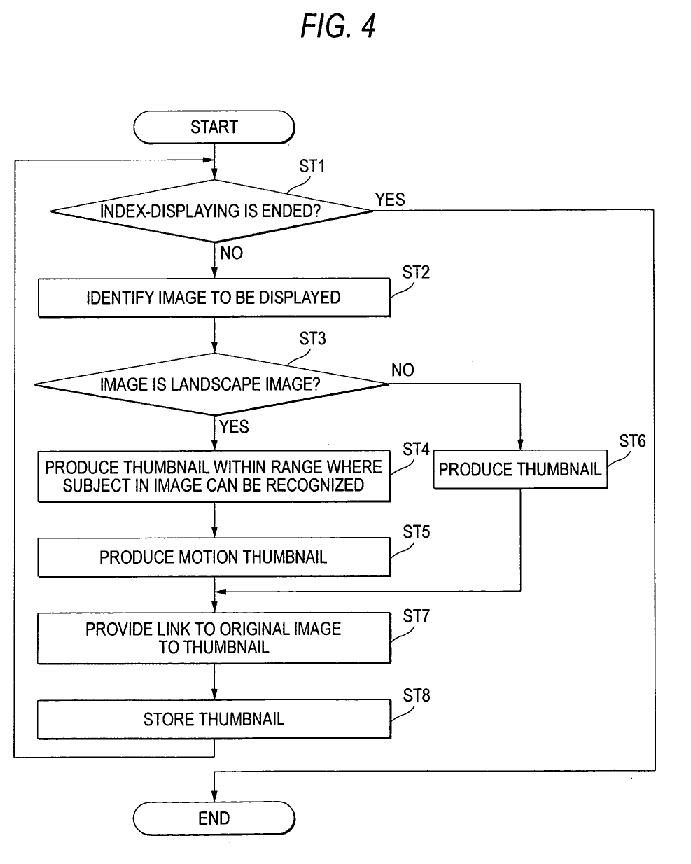

FIG. 4 is a flowchart illustrating a specific example of the operation of the image display device 100 shown in FIG. 2, in production of a thumbnail (reduced image).

Referring to FIG. 4, the operation of the image display device 100 in production of a thumbnail will be described with emphasis on the operation of the controlling section 200.

In step ST1, the controlling section 200 determines whether displaying of an index is ended or not. For example, the controlling section 200 determines on the basis of a signal input from the key operation section 102 whether displaying of an index is ended or not. If it is determined that displaying of an index is not ended, control proceeds to the process of step ST2, and, if it is determined that displaying of an index is ended, the process relating to production of a reduced image (thumbnail) is ended.

In step ST2, the controlling section 200 identifies an image to be indexed, among images stored in, for example, the storage device 106.

In step ST3, the thumbnail producing section 201 judges whether an original image is an image which has a size different from a specified size or not. If it is judged that the original image is an image which has a size different from the specified size, control proceeds to the process of step ST4, and, if it is judged that the original image has the specified size, control proceeds to the process of step ST6.

Specifically, for example, the thumbnail producing section 201 judges whether or not the original image is a landscape image (having as an aspect ratio of 1:5 or the like) which is different from an image having a specified size such as an aspect ratio of 3:4. If it is judged that the original image is a landscape image, control proceeds to the process of step ST4, and, if it is judged that the original image is not a landscape image, control proceeds to the process of step ST6.

In step ST4, as shown in FIG. 3, for example, the first motion thumbnail producing section 202a produces a reduced image 401 which corresponds to the landscape image 301, and which is to be displayed on the display area (the thumbnail display frame 10) for displaying a reduced image corresponding to the landscape image 301.

In this case, the first motion thumbnail producing section 202a produces the reduced image 401 by reducing the landscape image 301 while maintaining the aspect ratio so that the vertical dimension of the reduced image 401 corresponding to the landscape image 301 is equal to or smaller than that of the thumbnail display frame 10.

Namely, the first motion thumbnail producing section 202a reduces the original image at a reduction ratio which is calculated from the size ratio of the original image and the thumbnail display frame 10, to produce the reduced image (thumbnail). In this case, preferably, the first motion thumbnail producing section 202a produces the thumbnail (the reduced image 401) within the range where the subject in the image can be recognized.

In step ST5, the first motion thumbnail producing section 202a produces the moving reduced image 402 in which the reduced image 401 corresponding to the landscape image 301 is scrolled in the longitudinal (lateral direction) on the display areas (the thumbnail display frames 10) for displaying the reduced image 401 corresponding to the landscape image 301. Then, control proceeds to the process of step ST7. The moving reduced image 402 is referred to also as the motion thumbnail.

In the production of the moving reduced image 402, the first motion thumbnail producing section 202a produces the moving reduced image 402 in which the whole of the reduced image 401 is allowed to be looked over by scrolling the reduced image 401.

In step ST6, in the case where it is judged that the original image has the specified size or is a usual image of an aspect ratio of 3:4 (the original image is not a landscape image), the thumbnail producing section 201 produces a reduced image (thumbnail) of the specified aspect ratio of 3:4 so that the original image can be fitted into the thumbnail display frame 10. Then, control proceeds to the process of step ST7.

In step ST7, the original image correlating section 204 produces the link table TB1 while a link to the original image is provided to the thumbnail (moving reduced image 402) produced by the thumbnail producing section 201 and the first motion thumbnail producing section 202a.

In step ST8, the thumbnail storage section 205 stores the thumbnail (moving reduced image 402) produced by the thumbnail producing section 201 and the first motion thumbnail producing section 202a, in the storage device 106 on the basis of the link table TB1. Control returns to the process of step ST1.

Next, the operation of displaying the produced thumbnails (the reduced image, the moving reduced image) will be described.

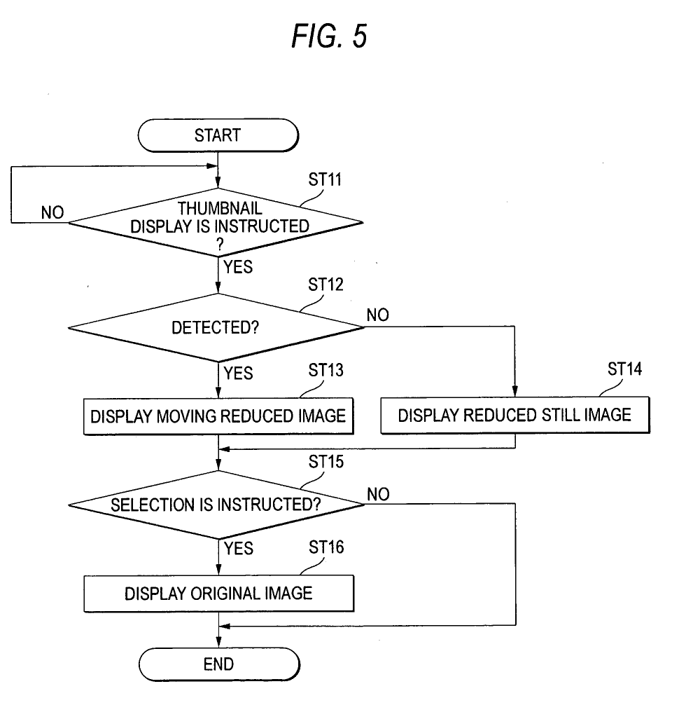

FIG. 5 is a flowchart illustrating a specific example of the operation of the image display device 100 shown in FIG. 2, in display of a thumbnail (reduced image).

Referring to FIG. 5, the operation of the image display device 100 when thumbnails are displayed will be described with emphasis on the operation of the controlling section 200.

In step ST11, the controlling section 200 judges whether or not a signal indicative of instructions for displaying a thumbnail is input from the key operation section 102 or the like. If it is judged that the signal indicative of instructions for displaying is input, control proceeds to the process of step ST12.

In step ST12, based on the link table TB1 stored in the memory 105 or the like, the detecting section 206 detects whether, in the plurality of the reduced images which are to be index-displayed on the display section 101, there is a reduced image corresponding to a landscape image or not. When a reduced image corresponding to a landscape image is detected, control proceeds to the process of step ST13, and, when such an image is not detected, control proceeds to the process of step ST14.

In step ST13, in the case where the detecting section 206 detects a reduced image corresponding to the landscape image 301, the thumbnail displaying section 208 displays an image in which the reduced image corresponding to the landscape image 301 is sequentially shifted (scrolled) in the longitudinal direction (lateral direction), in a display area (the thumbnail display frame 10) for displaying a reduced image corresponding to the landscape image 301 on the display screen of the display section 101.

Specifically, on the basis of the link table TB1 stored in the memory 105, the thumbnail displaying section 208 reads the thumbnail (moving reduced image 402) which is produced by the first motion thumbnail producing section 202a and stored in the storage device 106, and index-displays the thumbnail (moving reduced image 402) according to the invention on the display area of the display screen of the display section 101.

In step ST14, in the case where the detecting section 206 does not detect a reduced image corresponding to a landscape image, an image of the specified size, specifically a thumbnail (reduced still image) corresponding to a usual image of an aspect ratio of 3:4 is read out from the storage device 106, and, on the basis of the link table TB1, index-displays in the thumbnail display frame 10 of the display section 101. Control proceeds to the process of step ST15.

In step ST15, the controlling section 200 judges whether or not a signal indicative of instructions for selecting a desired thumbnail from thumbnails indexed on the display section 101 is input from the key operation section 102 or the like. If it is judged that the signal indicative of the selection instructions is input, control proceeds to the process of step ST16, and, if it is judged that the signal indicative of the selection instructions is not input, the series of processes is terminated.

In step ST16, on the basis of, for example, the selection instruction signal from the key operation section 102 and the link table TB1, the controlling section 200 reads the original image corresponding to the selected thumbnail (moving reduced image) from the storage device 106, and displays the image on the display section 101.

As described above, the embodiment has: the detecting section 206 which determines whether there is a reduced image corresponding to the landscape image 301 or not, in the plurality of reduced images which are to be index-displayed on the display section 101, to detect the reduced image corresponding to the landscape image 301; and the display section 101 and the thumbnail displaying section 208 which index-display the plurality of reduced images on the display area group (thumbnail display frames) of the display screen 101a, and which, when the detecting section 206 detects the reduced image corresponding to the landscape image 301, display an image in which the reduced image corresponding to the landscape image 301 is scrolled, in a display area (thumbnail display frame) where the reduced image corresponding to the landscape image 301 is to be displayed. Even when there is a reduced image of an image the size of which is different from the specified image size, therefore, index display of reduced images having a high visibility can be performed without involving a cumbersome operation.

Specifically, the first motion thumbnail producing section 202a which, on the display area where the reduced image corresponding to a landscape image is to be displayed, produces a moving reduced image in which the reduced image corresponding to a landscape image is sequentially shifted in the longitudinal direction, the storage device 106 which stores the moving reduced image produced by the first motion thumbnail producing section 202a, and the display section 101 which, on the display area where the reduced image corresponding to a landscape image is to be displayed, displays the moving reduced image corresponding to a landscape image stored in the storage device 106 are disposed. Therefore, the user can look a moving reduced image corresponding to a landscape image, in thumbnails which are index-displayed on the display section 101, whereby the user is enabled to easily know the whole and details of the image, and to distinguish a desired image from the plurality of images in a short time period.

As described above, a landscape image which has an aspect ratio different from a specified one is reduced so as to be fitted in a specified thumbnail frame, while maintaining the aspect ratio of the landscape image, and a part of the thumbnail is displayed without producing a small thumbnail (reduced image). Hence, there is an advantage that minute portions of the image can be easily seen.

Thumbnail display is performed by scrolling a thumbnail which is obtained by reducing a still image such as a landscape image to a moderate degree. Hence, there is an advantage that it is easy to know the whole of the original image.

When a motion thumbnail and a usual thumbnail are switchingly displayed by the motion thumbnail switching section 207, the user is enabled to select the manner of displaying each image. Therefore, the device can cope with various applications.

When the display format of thumbnails of all images is previously set to motion thumbnail display or still thumbnail display, there is an advantage that setting on each image can be eliminated.

### Second Embodiment

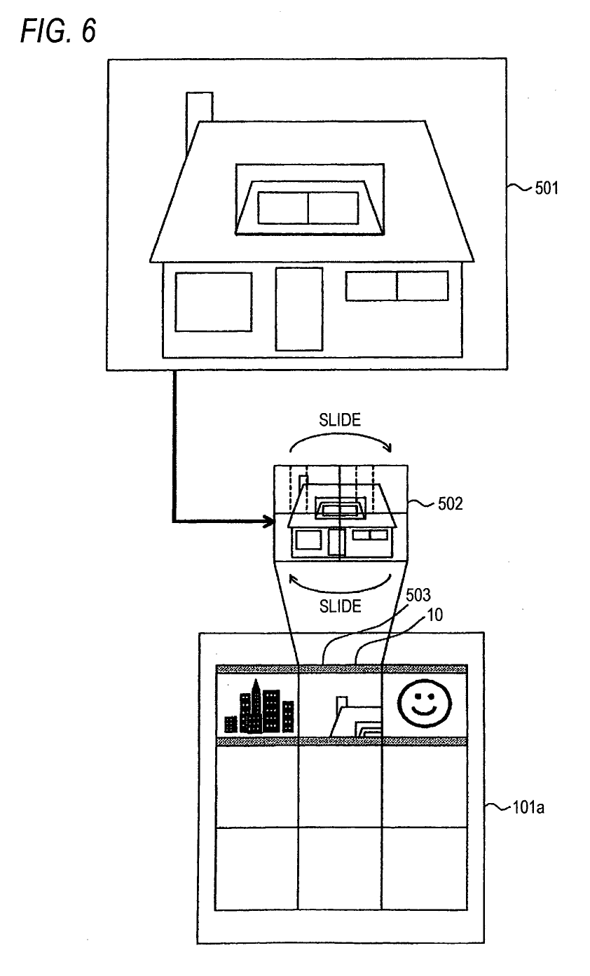

FIG. 6 shows an operation of an image display device 100 of a second embodiment of the invention, in display of a thumbnail.

Differences between the second embodiment and the first embodiment will be mainly described.

In the image display device 100 of the second embodiment, in the case where an original image is a high-resolution image 501 having pixels in number equal to or larger than a predetermined number, for example, an image 503 in which a reduced image 502 corresponding to the high-resolution image 501 is sequentially shifted (slid) is displayed in the thumbnail display frame 10 as shown FIG. 6.

Functional blocks of the image display device 100 of the embodiment are approximately identical with those shown FIG. 2, and description of functional blocks having a similar function is omitted. In the following description, emphasis is placed on differences.

The thumbnail producing section 201 has a second motion thumbnail producing section 202b.

As show in FIG. 6, for example, the second motion thumbnail producing section 202b produces a moving reduced image 503 in which the reduced image 502 corresponding to the high-resolution image 501 is sequentially shifted (slid), in a display area (the thumbnail display frame 10) where the reduced image corresponding to the high-resolution image 501 is to be displayed.

The original image correlating section 204 produces the link table TB1 which correlates the moving reduced image 503 produced by the second motion thumbnail producing section 202b with the original image.

The thumbnail storage section 205 stores the moving reduced image 503 produced by the second motion thumbnail producing section 202b, in the storage device 106 on the basis of the link table TB1.

The detecting section 206 in the embodiment determines whether there is a reduced image corresponding to a high-resolution image having pixels in number equal to or larger than the predetermined number or not, in reduced images which are to be index-display on the display section 101, to detect the reduced image corresponding to the high-resolution image.

The detecting section 206 in the embodiment corresponds to an example of the high-resolution image detecting section in the invention.

In the case where the detecting section 206 detects the reduced image corresponding to the high-resolution image 501, the thumbnail displaying section 208 displays the moving reduced image 503 in which the reduced image 502 corresponding to the high-resolution image is sequentially shifted, in a display area (the thumbnail display frame 10) where the reduced image corresponding to the high-resolution image is to be displayed.

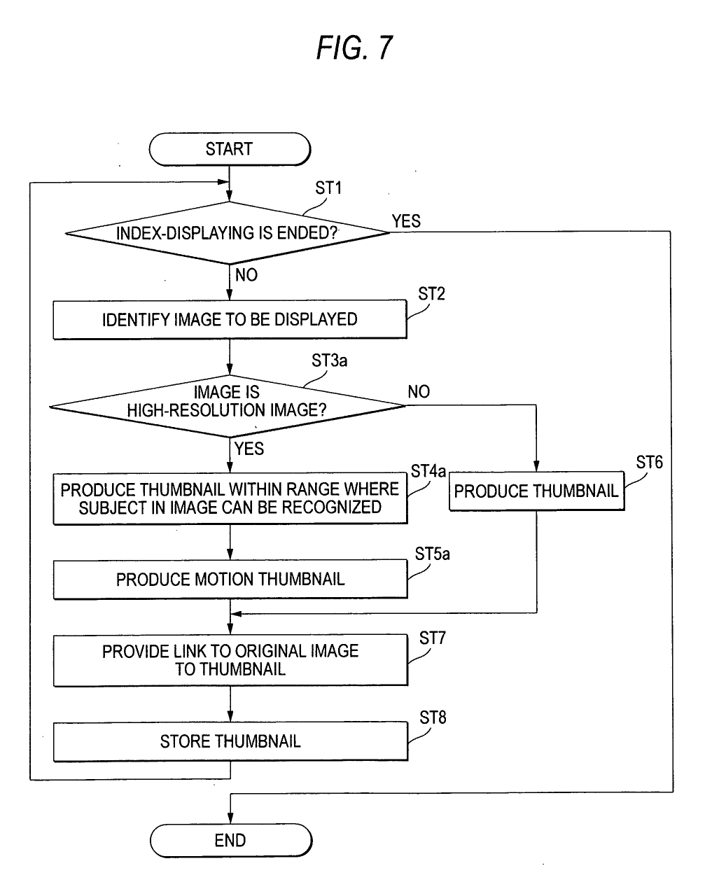

FIG. 7 is a flowchart illustrating a specific example of the operation of the image display device 100 shown in FIG. 6, in production of a thumbnail (reduced image).

Referring to FIG. 7, the operation of the image display device 100 in production of a thumbnail will be described with emphasis on differences from the first embodiment.

In step ST1, the controlling section 200 determines whether displaying of an index is ended or not. For example, the controlling section 200 determines on the basis of a signal input from the key operation section 102 whether displaying of an index is ended or not. If it is determined that displaying of an index is not ended, control proceeds to the process of step ST2, and, if it is determined that displaying of an index is ended, the process relating to production of a reduced image (thumbnail) is ended.

In step ST2, the controlling section 200 identifies an image to be indexed, among images stored in, for example, the storage device 106.

In step ST3a, the thumbnail producing section 201 judges whether an original image is the high-resolution image 501 having pixels in number equal to or larger than a predetermined number or not. If it is judged that the original image is the high-resolution image 501, control proceeds to the process of step ST4a, and, if it is judged that the original image is not the high-resolution image 501, control proceeds to the process of step ST6.

In step ST4a, as shown in FIG. 6, for example, the second motion thumbnail producing section 202b produces the moving reduced image 503 in which the reduced image 502 corresponding to the high-resolution image 501 is sequentially shifted (slid) on the display area (the thumbnail display frame 10) for displaying a reduced image corresponding to the high-resolution image 501.

In this case, preferably, the second motion thumbnail producing section 202b produces the thumbnail (the reduced image 502) within the range where the subject in the image can be recognized.

Steps ST6 to ST8 are substantially identical with those of the first embodiment shown in FIG. 4 in which “landscape image” reads “high-resolution image”. Therefore, their description is omitted.

Also an operation of displaying thumbnails (reduced image, moving reduced image) is substantially identical with that of the first embodiment shown in FIG. 5 in which “landscape image” reads “high-resolution image”. Therefore, its description is omitted.

The difference is as follows. When the detecting section 206 detects, in the plurality of reduced images which are to be index-display on the display section 101, a reduced image corresponding to the high-resolution image 501 having pixels in number equal to or larger than the predetermined number, as shown in FIG. 6, the thumbnail displaying section 208 displays the image 503 in which the reduced image 502 corresponding to the high-resolution image 501 is sequentially shifted, in a display area (thumbnail display frame 10) where the reduced image corresponding to the high-resolution image 501 is to be displayed.

Specifically, on the basis of the link table TB1 stored in the memory 105, the thumbnail displaying section 208 displays the moving reduced image 503 corresponding to the high-resolution image stored in the storage device 106, on the display area (thumbnail display frame 10) where the reduced image corresponding to the high-resolution image 501 is to be displayed.

As described above, in the image display device 100 of the embodiment, even when a high-resolution image in size equal to or larger than the specified size, for example, a predetermined pixel number is to be displayed in a thumbnail index, the moving reduced image 503 in which the reduced image 502 corresponding to the high-resolution image 501 is scrolled can be displayed on the display area (the thumbnail display frame 10). Therefore, the user can easily know the whole and details of the thumbnail of the high-resolution image, and distinguish a desired image from the plurality of images in a short time period.

### Third Embodiment

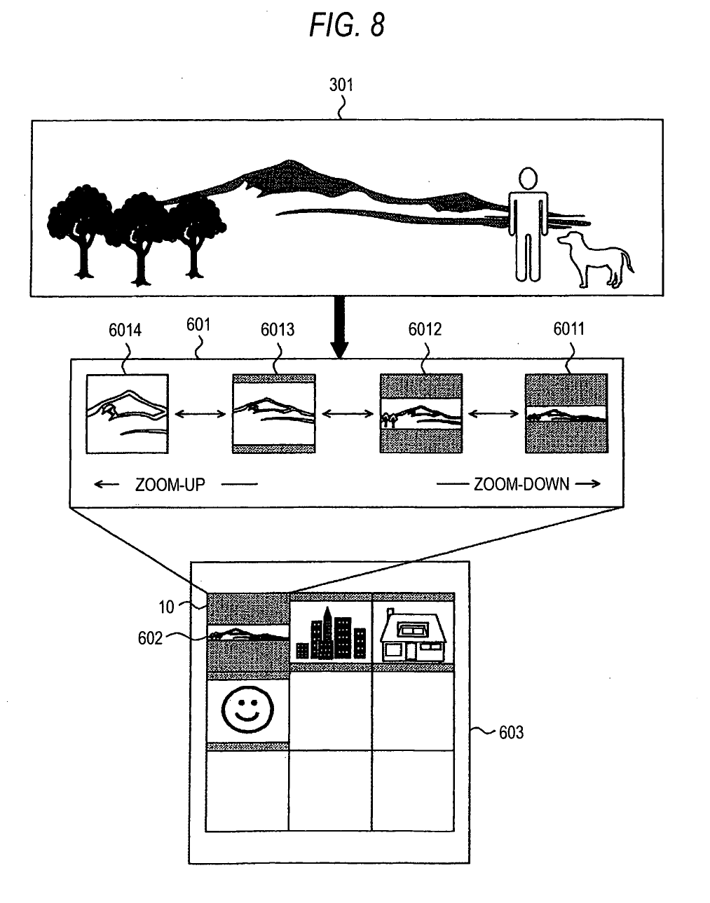

FIG. 8 shows an operation of an image display device 100 of a third embodiment of the invention, in display of a thumbnail.

Differences between the third embodiment and the first embodiment will be mainly described.

In the image display device 100 of the third embodiment, in the case where there is the landscape image 301 to be subjected to the thumbnail process, for example, a reduced image corresponding to the landscape image 301 is displayed in a gradually enlarging manner, or an image which is obtained by enlarging the reduced image corresponding to the landscape image 301 is displayed in a gradually reducing manner, in a display area (the thumbnail display frame 10) where a reduced image corresponding to the landscape image 301 is to be displayed, as shown in FIG. 8.

Namely, a reduced image is displayed in a gradually enlarging manner, or an image which is obtained by enlarging the reduced image is displayed in a gradually reducing manner.

Specifically, as shown in FIG. 8, the image display device 100 of the embodiment sequentially displays a reduced image 6011 corresponding to the landscape image 301, an image 6012 in which a middle area of the reduced image 6011 is enlarged, an image 6013 in which a middle area of the reduced image 6012 is enlarged, and an image 6014 in which a middle area of the reduced image 6013 is enlarged.

Conversely, as shown in FIG. 8, the image display device 100 of the embodiment sequentially displays the image 6014, the image 6013, the image 6012, and the image 6011.

In this case, the image display device 100 may alternatingly perform the above-mentioned sequential enlarging display and the sequential reducing display, thereby performing zoom-up display and zoom-down display of a thumbnail of the landscape image 301.

Functional blocks of the image display device 100 of the embodiment are approximately identical with those shown FIG. 2, and description of functional blocks having a similar function is omitted. In the following description, emphasis is placed on differences.

The thumbnail producing section 201 has a third motion thumbnail producing section 202c.

As show in FIG. 8, for example, the third motion thumbnail producing section 202c produces a moving reduced image 602 in which the reduced image 6011 corresponding to the landscape image 301 is gradually enlarged, or a moving reduced image 602 in which the image 6014 which is obtained by enlarging the reduced image 6011 corresponding to the landscape image 301 is gradually reduced, in a display area (the thumbnail display frame 10) where the reduced image corresponding to the landscape image 301 is to be displayed.

The storage controlling section 203 stores the moving reduced image 602 produced by the third motion thumbnail producing section 202c, in the storage device 106.

Specifically, the original image correlating section 204 produces the link table TB1 which correlates the moving reduced image 602 produced by the third motion thumbnail producing section 202c with the original image, and stores the table in the memory 105.

The thumbnail storage section 205 stores the moving reduced image 602 produced by the third motion thumbnail producing section 202c, in the storage device 106 on the basis of the link table TB1 produced by the original image correlating section 204.

The thumbnail displaying section 208 displays the moving reduced image 602 corresponding to the landscape image 301 stored in the storage device 106, on the display area (the thumbnail display frame 10) where the reduced image corresponding to the landscape image 301 is to be displayed.

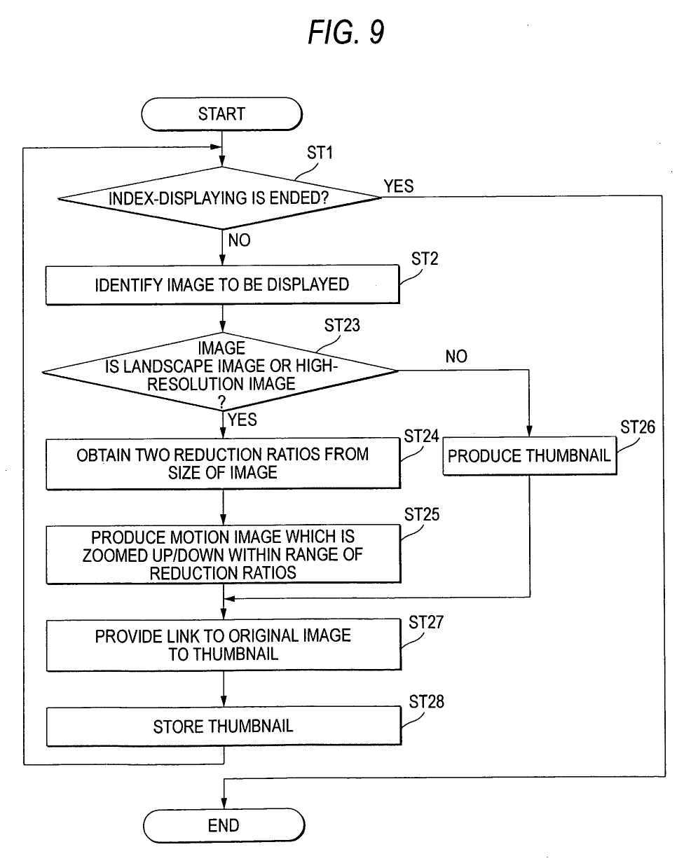

FIG. 9 is a flowchart illustrating a specific example of the operation of the image display device 100 of the third embodiment of the invention, in production of a thumbnail (reduced image).

Referring to FIG. 9, the operation of the image display device 100 in production of a thumbnail will be described with emphasis on differences from the first embodiment.

In step ST1, the controlling section 200 determines whether displaying of an index is ended or not. For example, the controlling section 200 determines on the basis of a signal input from the key operation section 102 whether displaying of an index is ended or not. If it is determined that displaying of an index is not ended, control proceeds to the process of step ST2, and, if it is determined that displaying of an index is ended, the process relating to production of a reduced image (thumbnail) is ended.

In step ST2, the controlling section 200 identifies an image to be indexed, among images stored in, for example, the storage device 106.

In step ST23, the thumbnail producing section 201 judges whether or not the original image is a landscape image (having as an aspect ratio of 1:5 or the like) which is different from an image having a specified size such as an aspect ratio of 3:4. If it is judged that the original image is a landscape image, control proceeds to the process of step ST24, and, if it is judged that the original image is not a landscape image, control proceeds to the process of step ST26.

In step ST24, as shown in FIG. 8, for example, the third motion thumbnail producing section 202c obtains a first reduction ratio which is calculated from the size of an image, and at which the image can be fitted into a thumbnail display frame, and a second reduction ratio which is calculated from a ratio of the original image and the size of the thumbnail display frame so as to enable the subject to be checked.

In step ST25, the third motion thumbnail producing section 202c produces the moving reduced image 602 in which the landscape image 301 is zoomed-up/zoomed-down within the range of the first and second reduction ratios.

Specifically, as shown in FIG. 8, the third motion thumbnail producing section 202c produces the images 601 (images 6011 to 6014), and combines the images 6011 to 6014 to produce the moving reduced image 602.

In step ST26, in the case where the image is not a landscape image, the thumbnail producing section 201 reduces the image so as to be fitted into the thumbnail display frame 10 to produce a thumbnail (reduced image). Then, control proceeds to the process of step ST27.

In step ST27, the original image correlating section 204 produces the link table TB1 while a link to the original image is provided to the thumbnail (moving reduced image 602) produced by the thumbnail producing section 201 and the third motion thumbnail producing section 202c.

In step ST28, the thumbnail storage section 205 stores the thumbnail (moving reduced image 602) produced by the thumbnail producing section 201 and the third motion thumbnail producing section 202c, in the storage device 106 on the basis of the link table TB1. Control returns to the process of step ST1.

Next, an operation of displaying produced thumbnails (reduced image, moving reduced image) will be described.

Also the operation of displaying thumbnails (reduced image, moving reduced image) is substantially identical with that of the first embodiment shown in FIG. 5. Therefore, description of similar points is omitted.

The difference is as follows. The detecting section 206 detects, in the plurality of reduced images which are to be index-displayed, a reduced image corresponding to a landscape image or not. When the detecting section 206 detects the reduced image corresponding to the landscape image 301, the thumbnail displaying section 208 performs display in which the reduced image corresponding to the landscape image 301 is gradually enlarged, or display in which an image which is obtained by enlarging the reduced image corresponding to the landscape image 301 is gradually reduced, in a display area (the thumbnail display frame 10) where the reduced image corresponding to the landscape image 301 is to be displayed.

Specifically, on the basis of the link table TB1 stored in the memory 105, the thumbnail displaying section 208 displays the moving reduced image 602 corresponding to the landscape image 301 stored in the storage device 106, in a display area (the thumbnail display frame 10) where the reduced image corresponding to the landscape image 301 is to be displayed.

As described above, the image display device 100 of the embodiment has: the detecting section 206 which determines whether there is a reduced image corresponding to the landscape image 301 or not, in the plurality of the reduced images which are to be index-displayed on the display section 101, to detect the reduced image corresponding to the landscape image 301; and the display section 101 which, when the detecting section 206 detects the reduced image corresponding to the landscape image 301, performs display in which a reduced image corresponding to the landscape image 301 is gradually enlarged, or display in which an image which is obtained by enlarging the reduced image corresponding to the landscape image is gradually reduced, in a display area (the thumbnail display frame 10) where the reduced image corresponding to the landscape image 301 is to be displayed, or namely zooms up/down the reduced image. When a thumbnail is reduced, therefore, the user can know the whole of the thumbnail, and, when a thumbnail is enlarged, the user can know the details of the thumbnail. The user can distinguish a desired image from the plurality of images in a short time period.

### Fourth Embodiment

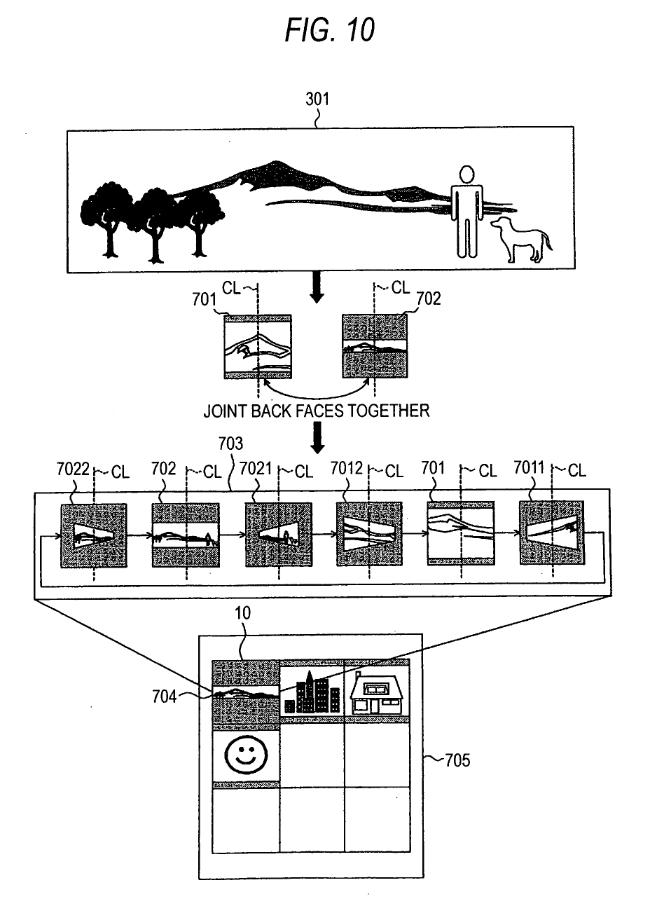

FIG. 10 shows an operation of an image display device 100 which is a fourth embodiment of the invention, in display of a thumbnail.

Differences between the fourth embodiment and the first embodiment will be mainly described.

In the image display device 100 of the fourth embodiment, in the case where there is the landscape image 301 to be subjected to the thumbnail process, for example, switching display and/or rotational display of a reduced image 702 corresponding to the landscape image 301, and an image 701 which is obtained by enlarging the reduced image are performed at a predetermined timing, in a display area (the thumbnail display frame 10) where the reduced image corresponding to the landscape image 301 is to be displayed, as shown in FIG. 10. For example, the images are sequentially displayed rotationally about a rotation axis CL passing through the images.

Specifically, as shown in FIG. 10, the image display device 100 of the embodiment displays the images 701 and 702 in the thumbnail display frame 10 of an index, as if the back faces of the images are joined together and the resulting image combination is rotated about the rotation axis CL which is a vertical axis passing the center of the image combination.

The rotational direction may be reversed. The images 701 and 702 may be displayed as if the image combination is rotated about a lateral axis passing the center of the image combination.

Functional blocks of the image display device 100 of the embodiment are approximately identical with those shown FIG. 2, and description of functional blocks having a similar function is omitted. In the following description, emphasis is placed on differences.

The thumbnail producing section 201 has a fourth motion thumbnail producing section 202d.

The fourth motion thumbnail producing section 202d displays at a predetermined timing the reduced image 702 corresponding to the landscape image 301, and the images which are obtained by enlarging the reduced image, switchingly and/or rotationally in sequence about the vertical axis passing the image center, in a display area (the thumbnail display frame 10) where the reduced image 702 corresponding to the landscape image 301 is to be displayed.

In the embodiment described above, the example in which both timing switching display and rotational display are performed. Alternatively, a mode in which only switching display or rotational display is simply performed may be employed.

Specifically, as shown in FIG. 10, for example, the fourth motion thumbnail producing section 202d produces: the reduced image 702 corresponding to the landscape image 301; an image 7021 which is swung about the vertical axis passing the image center so that the right side of the reduced image 702 as one faces is in the front side and the left side is in the rear side; an image 7022 which is swung about the vertical axis passing the image center so that the right side of the reduced image 702 as one faces is in the rear side and the left side is in the front side; the image 701 which is obtained by enlarging the reduced image 702; an image 7011 which is swung about the vertical axis passing the image center so that the right side of the reduced image 701 as one faces is in the front side and the left side is in the rear side; and an image 7012 which is swung about the vertical axis passing the image center so that the right side of the reduced image 701 as one faces is in the rear side and the left side is in the front side. The images 701, 7011, 7022, 702, 7021, and 7012 are combined with each other to produce an image 703, and a moving reduced image 704 in which the images 701, 7011, 7022, 702, 7021, 7012, 701, . . . are sequentially shown is produced.

The storage controlling section 203 stores the moving reduced image 704 produced by the fourth motion thumbnail producing section 202d, in the storage device 106.

Specifically, the original image correlating section 204 produces the link table TB1 which correlates the moving reduced image 704 produced by the fourth motion thumbnail producing section 202d with the original image, and stores the table in the memory 105.

The thumbnail storage section 205 stores the moving reduced image 704 produced by the fourth motion thumbnail producing section 202d, in the storage device 106 on the basis of the link table TB1 produced by the original image correlating section 204.

The thumbnail displaying section 208 displays the moving reduced image 704 corresponding to the landscape image 301 stored in the storage device 106, in a display area (the thumbnail display frame 10) where the reduced image corresponding to the landscape image 301 is to be displayed.

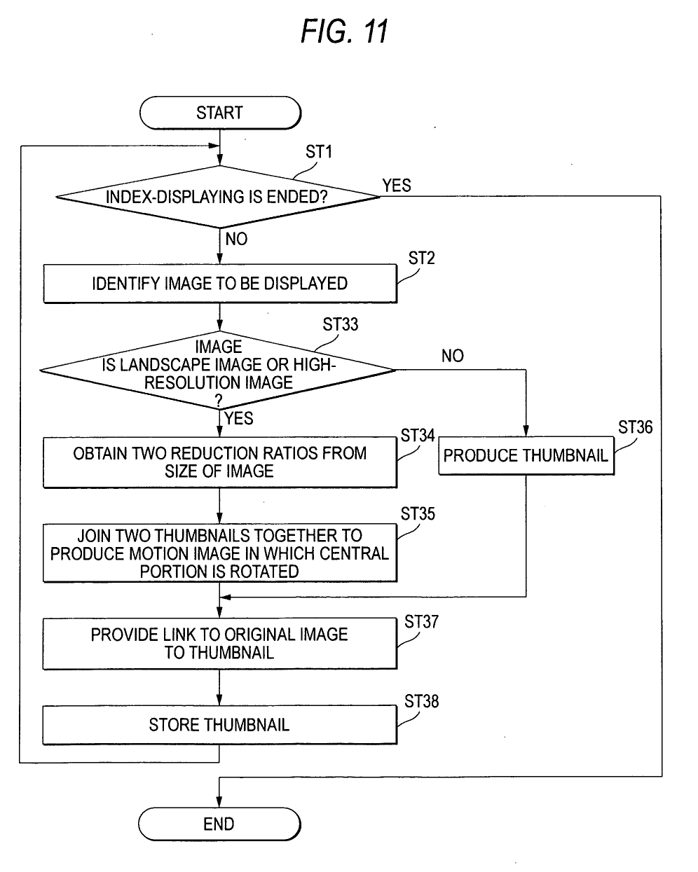

FIG. 11 is a flowchart illustrating a specific example of the operation of the image display device 100 of the fourth embodiment of the invention, in production of a thumbnail (reduced image).

Referring to FIG. 11, the operation of the image display device 100 in production of a thumbnail will be described with emphasis on differences from the first embodiment.

In step ST1, the controlling section 200 determines whether displaying of an index is ended or not. For example, the controlling section 200 determines on the basis of a signal input from the key operation section 102 whether displaying of an index is ended or not. If it is determined that displaying of an index is not ended, control proceeds to the process of step ST2, and, if it is determined that displaying of an index is ended, the process relating to production of a reduced image (thumbnail) is ended.

In step ST2, the controlling section 200 identifies an image to be indexed, among images stored in, for example, the storage device 106.

In step ST33, the thumbnail producing section 201 judges whether or not the original image is a landscape image (having as an aspect ratio of 1:5 or the like) which is different from an image having a specified size such as an aspect ratio of 3:4. If it is judged that the original image is a landscape image, control proceeds to the process of step ST34, and, if it is judged that the original image is not a landscape image, control proceeds to the process of step ST36.

In step ST34, as shown in FIG. 10, for example, the fourth motion thumbnail producing section 202d obtains a first reduction ratio which is calculated from the size of an image, and at which the image can be fitted into a thumbnail display frame, and a second reduction ratio which is calculated from a ratio of the original image and the size of the thumbnail display frame so as to enable the subject to be checked, and produces the image 702 which is obtained by reducing the landscape image 301 at the first reduction ratio, and the image 701 which is obtained by reducing the landscape image 301 at the second reduction ratio.

In step ST35, the fourth motion thumbnail producing section 202d produces the moving reduced image 704 which can be seen as if the back faces of the images 701, 702 are joined together and the joined image combination is rotated about the vertical axis passing the center of the image combination.

Specifically, as described above, as shown in FIG. 10, the fourth motion thumbnail producing section 202d produces: the reduced image 702 corresponding to the landscape image 301; the image 7021 which is swung about the vertical axis passing the image center so that the right side of the reduced image 702 as one faces is in the front side and the left side is in the rear side; the image 7022 which is swung about the vertical axis passing the image center so that the right side of the reduced image 702 as one faces is in the rear side and the left side is in the front side; the image 701 which is obtained by enlarging the reduced image 702; the image 7011 which is swung about the vertical axis passing the image center so that the right side of the reduced image 701 as one faces is in the front side and the left side is in the rear side; and the image 7012 which is swung about the vertical axis passing the image center so that the right side of the reduced image 701 as one faces is in the rear side and the left side is in the front side. The image 703 is produced by combining the images 701, 7011, 7022, 702, 7021, and 7012 with each other, to produce the moving reduced image 704 in which the images 701, 7011, 7022, 702, 7021, 7012, 701, . . . are sequentially shown.

In step ST36, in the case where the image is not a landscape image, the thumbnail producing section 201 reduces the image so as to be fitted into the thumbnail display frame 10 to produce a thumbnail (reduced image). Then, control proceeds to the process of step ST37.

In step ST37, the original image correlating section 204 produces the link table TB1 while a link to the original image is provided to the thumbnail (moving reduced image 704) produced by the thumbnail producing section 201 and the fourth motion thumbnail producing section 202d.

In step ST38, the thumbnail storage section 205 stores the thumbnail (moving reduced image 704) produced by the thumbnail producing section 201 and the fourth motion thumbnail producing section 202d, in the storage device 106 on the basis of the link table TB1. Control returns to the process of step ST1.

Next, an operation of displaying produced thumbnails (reduced image, moving reduced image) will be described.

Also the operation of displaying thumbnails (reduced image, moving reduced image) is substantially identical with that of the first embodiment shown in FIG. 5. Therefore, description of similar points is omitted.

The difference is as follows. The detecting section 206 determines whether there is a reduced image corresponding to a landscape image or not, in the plurality of the reduced images which are to be index-displayed, to detect the reduced image corresponding to the landscape image. When the detecting section 206 detects the reduced image corresponding to the landscape image 301, the thumbnail displaying section 208 performs at a predetermined timing switching display and/or rotational display of the reduced image 702 corresponding to the landscape image 301, and images which are obtained by enlarging the reduced image 702, in a display area (the thumbnail display frame 10) where the reduced image corresponding to the landscape image 301 is to be displayed.

Specifically, on the basis of the link table TB1 stored in the memory 105, the thumbnail displaying section 208 displays the moving reduced image 704 corresponding to the landscape image 301 stored in the storage device 106, in a display area (the thumbnail display frame 10) where the reduced image corresponding to the landscape image 301 is to be displayed.

As described above, in the image display device 100 of the embodiment, the reduced image 702 corresponding to the landscape image 301, and images which are obtained by enlarging the reduced image 702 are switched over at a predetermined timing and displayed sequentially rotatingly about the rotating axis which is the vertical axis passing the image center. Therefore, the whole and details of a thumbnail of the landscape image 301 can be easily known, and a desired image can be distinguished from the plurality of images in a short time period.

Furthermore, display is performed as if the image is rotated. Therefore, the user can be surely informed that a thumbnail of a landscape image is displayed.

The invention is not restricted to the embodiments, and various arbitral modifications are enabled.

In the third and fourth embodiment, display of a landscape image has been described. The invention is not restricted to the embodiments. Similarly, display of a high-resolution image may be performed by the operations of the embodiments.

In the embodiments described above, a moving reduced image is displayed in which a reduced image corresponding to a landscape image or a high-resolution image is scroll-displayed. The invention is not restricted to the embodiments. For example, the plurality of still images are displayed so as to perform scroll display, by producing the plurality of reduced images which can be virtually scroll-displayed, and switchingly displaying the plurality of reduced images.

The invention can be applied to, for example, an image display device which index-displays thumbnails (reduced images) of images.

What is claimed is:

1. An image display device, comprising:
a displaying section which index-displays a plurality of reduced images; and
an image determining section which determines whether there is a reduced image corresponding to a landscape image or not, in the plurality of the reduced images which are to be index-displayed on the displaying section,
wherein when the image determining section determines the reduced image corresponding to the landscape image, the displaying section scroll-displays the reduced image corresponding to the landscape image, on a display area where the reduced image is to be displayed.

2. The image display device according to claim 1, further comprising:
a moving reduced image producing section which produces a moving reduced image in which the reduced image corresponding to the landscape image is scrolled; and
a storage section which stores the moving reduced image produced by the moving reduced image producing section,
wherein the displaying section displays the moving reduced image corresponding to the landscape image stored in the storage section, on the display area.

3. The image display device according to claim 1,
wherein the landscape image is a panoramic image.

4. An image display device, comprising:
a displaying section which index-displays a plurality of reduced images; and
an image determining section which determines whether there is a reduced image corresponding to a landscape image or not, in the plurality of reduced images which are to be index-displayed on the displaying section,
wherein when the image determining section determines the reduced image corresponding to the landscape image, the displaying section displays the reduced image corresponding to the landscape image while the reduced image is gradually enlarged, or while an image obtained by enlarging the reduced image corresponding to the landscape image is gradually reduced, on a display area where the reduced image is to be displayed.

5. The image display device according to claim 4, further comprising:
a moving reduced image producing section which produces a moving reduced image in which the reduced image corresponding to the landscape image is gradually enlarged, or in which the image obtained by enlarging the reduced image corresponding to the landscape image is gradually reduced; and
a storage section which stores the moving reduced image produced by the moving reduced image producing section,
wherein the displaying section displays the moving reduced image corresponding to the landscape image stored in the storage section, on the display area.

6. The image display device according to claim 4,
wherein the landscape image is a panoramic image.

7. An image display device, comprising:
a displaying section which index-displays a plurality of reduced images; and
an image determining section which determines whether there is a reduced image corresponding to a landscape image or not, in the plurality of the reduced images which are to be index-displayed on the displaying section, and
wherein when the image determining section determines the reduced image corresponding to the landscape image, the displaying section displays the reduced image corresponding to the landscape image and an image obtained by enlarging the reduced image, by switching and/or by rotating the determined image and the enlarged image on a display area where the reduced image is to be displayed at a predetermined timing.

8. The image display device according to claim 7, further comprising:
a moving reduced image producing section which produces a moving reduced image in which the reduced image corresponding to the landscape image and the image obtained by enlarging the reduced image are displayed by switching and/or rotating at the predetermined timing; and
a storage section which stores the moving reduced image produced by the moving reduced image producing section,
wherein the displaying section displays the moving reduced image corresponding to the landscape image stored in the storage section, on the display area.

9. The image display device according to claim 7,
wherein the landscape image is a panoramic image.

10. An image display device, comprising:
a displaying section which index-displays a plurality of reduced images; and
a high-resolution image determining section which determines whether there is a reduced image corresponding to a high-resolution image having pixels in number equal to or larger than a predetermined number or not, in the plurality of the reduced images which are to be index-displayed on the displaying section,
wherein when the high-resolution image determining section determines the reduced image corresponding to the high-resolution image, the displaying section scroll-displays the reduced image corresponding to the high-resolution image, on a display area where the reduced image is to be displayed.

11. The image display device according to claim 10, further comprising:
a moving reduced image producing section which produces a moving reduced image in which the reduced image corresponding to the high-resolution image is scrolled; and
a storage section which stores the moving reduced image produced by the moving reduced image producing section,
wherein the displaying section displays the moving reduced image corresponding to the high-resolution image stored in the storage section, on the display area.
